(19) United States
(12) Patent Application Publication
(10) Pub. No.: US 2026/0070174 A1
(43) Pub. Date: Mar. 12, 2026

(54) WORKPIECE SUPPORT

(71) Applicant: Zell Systemtechnik GmbH, Ehingen-Volkersheim (DE)

(72) Inventor: Ingo Zell, Ehingen (DE)

(73) Assignee: Zell Systemtechnik GmbH, Ehingen-Volkersheim (DE)

(21) Appl. No.: 19/394,570

(22) Filed: Nov. 19, 2025

Related U.S. Application Data
(63) Continuation of application No. PCT/EP2024/063753, filed on May 17, 2024.

(30) Foreign Application Priority Data
May 19, 2023 (DE) 10 2023 113 226.1

(51) Int. Cl. B23Q 3/06; B23Q 3/10

(52) U.S. Cl. CPC B23Q 3/061; B23Q 3/10

(57) ABSTRACT

Workpiece carrier in which a plurality of workpieces can be arranged in an array. The workpiece carrier comprising at least two side longitudinal supports, spring-loaded partition walls which extend between the two longitudinal supports and are displaceable along the longitudinal supports, wherein between two adjacent partition walls at least one receiving region for one or more workpieces is defined, which is laterally delimited by adjacent longitudinal supports, and a displacement mechanism, with which the partition walls are displaceable against a spring force, so that the workpieces in the receiving regions are held frictionally by the adjacent partition walls.

### FIELD

The present disclosure relates to a workpiece carrier in which a plurality of workpieces can be arranged in an array (a multiple arrangement).

### BACKGROUND

Heating and/or drying steps are included in battery production. In these steps, battery cell components are heated and/or dried over a longer period of time in a process station provided for this purpose. During these steps, the battery cell components are arranged in a workpiece carrier in which they are securely held. The battery cell components are also transported into and out of the manufacturing station in the workpiece carrier. Several workpiece carriers can be stacked so that the battery cell components can be processed in a predetermined arrangement in the manufacturing station and are protected by the workpiece carrier during transportation and production as well as possible intermediate storage.

JP 2002-2708 A shows a container with movable partitions whose lateral lugs engage in grooves in the container side walls. Spring elements between a container end wall and a partition wall allow the partition walls and the objects arranged between them to be pushed together.

EP 3290 152 A1 shows a workpiece carrier with movable support elements that can be moved on lateral rails.

DE 20 2018 107 171 U1 discloses a container with partition walls extending transversely between the container side walls and longitudinal subdivision webs arranged between two adjacent partition walls.

### SUMMARY

It is an object to provide a workpiece carrier for workpieces, which holds the workpieces securely in an array. Specifically, it is an object to provide a workpiece carrier that holds battery cell components securely in an array.

According to an aspect of the present disclosure, there is provided a workpiece carrier in which a large number of workpieces can be arranged in an array. The workpiece carrier comprises at least two longitudinal supports and spring-loaded partition walls which extend between the two longitudinal supports and are displaceable along the longitudinal supports, wherein between two adjacent partition walls at least one receiving region for one or more workpieces is defined, which is laterally delimited by adjacent longitudinal supports. A displacement mechanism is provided, by means of which the partition walls are displaceable against a spring force, such that the workpieces in the receiving regions are frictionally held by the adjacent partition walls.

The workpiece carrier is configured to hold workpieces. A workpiece is a component to be processed or transported. The workpiece carrier holds the workpieces ready for these purposes. Battery cell components as exemplary workpieces can be end products or intermediate products from which batteries or their components are manufactured. The term battery cell components also includes batteries. The batteries or their components or intermediates can be rechargeable or only dischargeable once.

In the case of workpieces arranged in an array (a multiple arrangement), several workpieces are accommodated in the workpiece carrier. The workpieces can be placed in regions provided for this purpose. The size of such a region for holding the workpiece can exceed the size of the workpiece, and can be provided with at least enough play to place the workpiece therein.

The receiving region is defined by adjacent partition walls and adjacent longitudinal supports. They limit the receiving region longitudinally or laterally. Further receiving regions are defined by an outer wall and the adjacent partition wall as well as adjacent longitudinal supports, so that workpieces can also be frictionally held between this outer wall and the adjacent partition wall. The frictional connection (i.e. a non-positive fit) is created by the forces acting between the components. Pressure or, in particular, frictional forces that arise from the pressing together of the components keep the components in their position. Nonetheless, the frictional connection can be supported by a positive connection in various embodiments.

By moving the partition walls, the workpieces are clamped between two adjacent partition walls and held by a frictional connection of the two partition walls, which press against the workpieces from opposite sides. In the same way, the partition wall adjacent to the outer wall is displaced and holds the workpieces arranged between it and the outer wall in a frictional connection. The explanations below regarding holding the workpieces between two adjacent partition walls and the means provided for this also apply to the workpieces between the outer wall and the adjacent partition wall. However, the outer wall is not moved.

The partitions walls are spring-loaded so that they can be moved against a spring force or supported by a spring force. When forming the frictional connection, the displacement takes place against the spring force. Advantageously, the workpiece carrier is also pretensioned even when not loaded with workpieces, so that a spring force already acts on the partition walls in their predetermined basic position, from which they are displaced to form the frictional connection for holding the workpieces. The partition walls can be spring-coupled, so that the displacement of one partition wall is transmitted to the other partition walls via elastically deformable springs.

By means of the displacement mechanism, the partition walls are displaceable against a spring force so that the workpieces are pressed into the receiving regions between the adjacent partition walls and held frictionally. This prevents the workpieces from slipping out between the partitions. In various embodiments, the partition walls are straight. Alternatively, the partition wall part facing the workpiece can be adapted to the shape of the workpiece, for example by means of a bulge.

In various embodiments, one or more workpieces from the plurality of workpieces can be arranged in the receiving regions. With multiple workpieces, these can be arranged in a row along the partition walls, so that each workpiece in this row is clamped between the adjacent partition walls. In various embodiments, the held workpiece can extend over several receiving regions, which implies that the same workpiece can be arranged in these receiving regions. In various embodiments, the partition walls may have holes through which the longitudinal supports extend, so that the partition walls are both movable and guided and held by the longitudinal supports. Alternatively, edge-open notches can be provided for this purpose.

In various embodiments, the longitudinal supports extend between two opposite outer walls. At least two of the longitudinal supports are firmly connected to the outer walls to define the distance between the outer walls. Welded or bolted connections are possible. The other longitudinal supports, if present, can also be firmly connected or have play to prevent jamming during assembly. The longitudinal supports can, for example, have a round or square cross-section.

Holding rods in form of retaining bars can extend between two opposite outer walls, on which the workpieces can be placed from above during loading, without them sliding down from the workpiece carrier. The partition walls are also movable along or on top the holding rods. The holding rods can extend below the partition walls or through holes or egde-open notches of the partition walls.

Advantageously, the receiving regions are arranged in rows and columns, with the columns extending along the longitudinal supports between the outer sides and the rows extending along the partition walls. Rows and columns extend transversely to each other. In various embodiments, there is only one column providing wide receiving regions.

Advantageously, outer longitudinal supports extend along the opposite outer sides of the workpiece carrier, which, together with the outer walls, increase the stability of the workpiece carrier through the resulting frame structure. Alternatively, receiving regions are provided in an external column, the outer side of which is not bounded by a longitudinal support. The frictional connection through the partition walls nevertheless allows for secure, frictionally connected support for the workpieces even in the receiving regions of the outer columns.

In various embodiments, more than one longitudinal support extends on the same outer side and/or between two adjacent columns. Thus, the longitudinal supports can be arranged in pairs on the same outer side and/or between two adjacent columns, for example. In one embodiment, the two longitudinal supports of the pair can then be arranged one above the other. This improves stability.

Advantageously, at least one spring is coupled between two adjacent partition walls. The spring is an elastically deformable element between adjacent partition walls, which is compressed when the partition walls are moved towards each other. Deformed in this way, the spring force of the elastic element acts against the compression direction and presses on the partition walls. The spring force causes the compressed partition walls to move away from each other again when the compressive force decreases. This releases the frictional connection that holds the workpieces and enables the workpieces to be removed from the workpiece carrier. In a non-loaded state of the workpiece carrier, the spring can be preloaded.

In various embodiments, the spring is designed to extend around the longitudinal support and is supported in the preloaded state by the partition walls. Such a spring can be a coil spring made of wire wound spirally around the longitudinal support. In various embodiments, coil springs are on each of the longitudinal supports between the adjacent partition walls and the outer wall and the partition wall adjacent to it. In an alternative embodiment, such arranged springs are not provided on all longitudinal supports. In a further embodiment, between the adjacent partition walls and the outer wall and the adjacent partition wall, there are not coil springs on each of the longitudinal supports extending between them, with the longitudinal supports carrying springs not being the same for all pairs of adjacent partition walls.

The displacement mechanism is configured to move the partition walls to form the frictional connection and fix the displacement of the partition walls, so that the workpieces are held frictionally. The displacement mechanism is arranged on the other outer wall and moves the adjacent first partition wall away from the outer wall. There are no receiving regions provided between the outer wall with the displacement mechanism and the first partition wall. The displacement mechanism causes the adjacent first partition wall to press the workpieces arranged on it against the partition wall adjacent to the first partition wall, which then subsequently has the same effect on the workpieces arranged on it, until all workpieces between the partition walls have been pushed together and are held frictionally. The displacement mechanism is configured to change the distance of the first partition wall to the outer wall. The distance is increased to form the frictional connection. To release the frictional connection, the distance is reduced, causing the spring effect to move the partitions apart again.

In various embodiments, the displacement mechanism comprises at least one spacer, which establishes the distance to the first partition wall. Moving the spacer also changes the distance. Such a displacement mechanism can include an internal thread on the outer wall and a screw with an external thread as a spacer, which is turned through the internal thread against the first partition wall, thereby displacing it.

In various embodiments, the displacement mechanism includes a lever that is configured to space the first partition wall from the outer wall. Such a lever can, for example, be designed as a toggle lever. Advantageously, the lever can be locked after establishing the frictional connection, so that it remains in its position for frictionally holding the workpieces. Alternative means for the displacement mechanism can be, for example, a wedge or a bolt.

The components of the workpiece carrier can be made of metal, which is stable and heat-resistant. The connections between longitudinal supports and outer walls can be bolted, so the connections are detachable, allowing the exchange of components and their use in other workpiece carriers. The partition walls and the springs are only placed on the longitudinal supports. The springs are pretensioned when attaching the longitudinal supports to the outer walls. A workpiece carrier assembled in this way offers degrees of freedom in its design, as various components can be assembled as needed. The workpiece carrier is sustainable because the components are reusable. For example, the longitudinal supports used can be selected from longitudinal supports of different lengths.

### BRIEF DESCRIPTION OF THE DRAWINGS

Embodiments of the invention are shown in the drawings and are explained in more detail in the following description.

FIG. 1 shows a three-dimensional arrangement of an example of a workpiece carrier.

FIG. 2 shows a top view of the workpiece carrier.

FIG. 3 shows a bottom view of the workpiece carrier.

FIG. 4 shows a side view of the workpiece carrier.

FIG. 5 shows a three-dimensional detailed sectional view of the workpiece carrier.

In the figures, identical or functionally equivalent components are provided with the same reference numerals.

### DETAILED DESCRIPTION

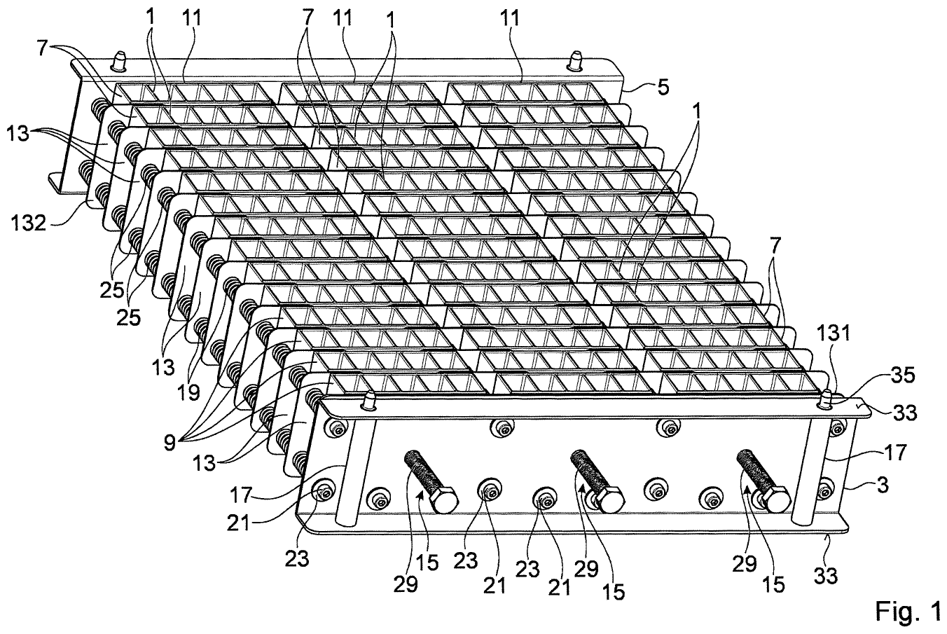

FIG. 1 shows a three-dimensional arrangement of an embodiment of a workpiece carrier for workpieces 1, which in this embodiment are battery cell components 1. In the workpiece carrier, a variety of battery cell components can be arranged as exemplary embodiments of workpieces 1 in an array. The battery cell components as workpieces 1 are securely held in position by the workpiece carrier.

The workpiece carrier comprises a front outer wall 3 and a rear outer wall 5, between which receiving regions 7 for the battery cell components 1 are provided. Terms such as “front”, “back”, “top”, “bottom”, and similar do not denote absolute positions in space, but rather illustrate the arrangement of the components relative to each other. In this embodiment, the receiving regions 7 are completely or largely filled by the battery cell components 1. The receiving regions 7 are arranged in rows 9 and columns 11. The columns 9 extend longitudinally between the outer walls 3, 5. The rows 11 transversely to them. Between the rows 11, spring-loaded, movable partition walls 13 are provided, which, in a pushed-together state, hold the battery cell components 1 in the receiving regions 7 between two adjacent partition walls 13 by frictional connection. A displacement mechanism 15 is configured to displace the partition walls 13 so that the battery cell components 1 are securely clamped between adjacent partition walls 13 and held by frictional connection. The displacement mechanism 15 also fixes the positions of partition walls 13 and battery cell components 1.

In the same way, receiving regions 7 are defined between the rear outer wall 5 and the adjacent partition wall 132, in which the battery cell components 1 are held by the movable adjacent partition wall 132 and the rear outer wall 5 in a frictional connection.

Pin-shaped stacking aids 17 projecting upwards on the front outer wall 3 and the rear outer wall 5 in the corner areas of the workpiece carrier facilitate the stacking of the workpiece carriers by engaging upwardly projecting tips 35 of the stacking aids 17 into corresponding recesses 39 of a stacked workpiece carrier.

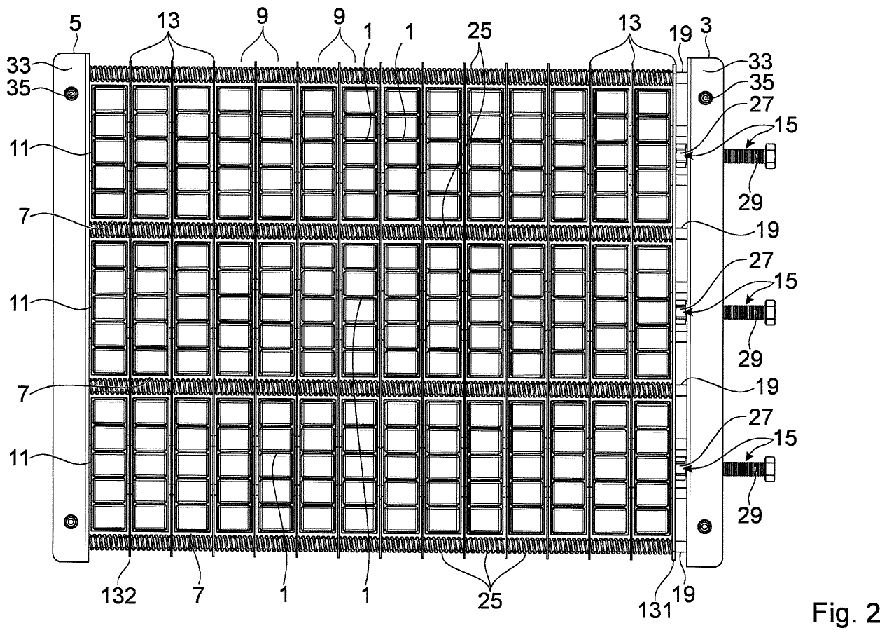

FIG. 2 shows a top view of the workpiece carrier from FIG. 1. Between the front outer wall 3 and the rear outer wall 5, a plurality of movable partition walls 13 are arranged. A first partition wall 131 is arranged adjacent to the front outer wall 3. By shifting, its distance to the front outer wall 3 can be changed. When it is pushed towards the rear outer wall 5, its distance to the front outer wall 3 increases and causes the depth of the receiving regions 7, which is the distance between adjacent partition walls 13, to be reduced.

Between the front outer wall 3 and the rear outer wall 5, longitudinal supports 19 extend. In this embodiment, eight pairs of equidistantly arranged longitudinal supports 19 are provided, which are firmly connected to the front outer wall 3 and the rear outer wall 5. The connection can be made, for example, by welding or screwing. In this exemplary embodiment, the longitudinal supports 19 have front-end internal threads, into which screws 21 engage through holes and washers 23 in the front outer wall 3 and the rear outer wall 5, so that the front outer wall 3 and the rear outer wall 5 are fixed between the longitudinal supports 19 as well as the screw heads and washers 23, since the holes have a smaller diameter.

Springs 25 are coupled between the rear outer wall 5 and its neighboring partition wall 132 as well as between neighboring partition walls 13. The springs 25 can be spiral springs that wind around the longitudinal supports 19 and are supported in a pretensioned state on the rear outer wall 5 and the adjacent partition wall 132 or between adjacent partition walls 13. Eight coil springs 25, one on each longitudinal support 19, are arranged in this exemplary embodiment between the rear outer wall 5 and the adjacent partition wall 132 or between two adjacent partition walls 13. The springs 25 are also preloaded when the workpiece carrier is not loaded. The length of the springs 25 arranged in series in a relaxed state on a longitudinal support 19 is greater than the distance between the outer walls 3, 5.

The displacement mechanism 15 includes screw nuts 27 with an internal thread attached to the front outer wall 3 and displacement screws 29 whose external thread engages with the internal thread. In this exemplary embodiment, three displacement screws 29 and three screw nuts 27 are provided by way of example, one for each column 11. More or fewer displacement screws 29 and screw nuts 27 can be provided. The screw nuts 27 are firmly connected, for example welded, to the front outer wall 3. They are provided on the inside of the front outer wall 3, so that the first partition 131 is spaced from the front outer wall 3 by at least the height of the screw nuts 27. The front end of the screw shaft presses on the first partition wall 131 and can thereby push it away from the front outer wall 3. When the displacement screws 29 are turned back, the pre-tension of the springs 25 causes the movement of the first partition wall 131 and the other partition walls 13 in the opposite direction. Turning the displacement screws 29, the length of the screw shaft, which extends into the interior of the workpiece carrier via the screw nut 27, is changed, thus moving the first partition wall 131 away from the front outer wall 3. The shaft projecting into the interior, together with the height of the screw nut 27, defines the distance between the first partition wall 131 and the front outer wall 3.

The receiving regions 7 are defined by adjacent partition walls 13 and adjacent longitudinal supports 19. In each receiving region 7, one or more battery cell components 1 can be arranged. If there are several battery cell components 1, these are arranged in a row along the partition wall 13. In this exemplary embodiment, a battery cell component 1 with a rectangular contour and five cavities is arranged in each receiving region 7. The illustrated battery cell component 1 is an exemplary embodiment of a workpiece that can be held by the workpiece carrier and is shown in merely exemplary design. The workpiece 1 to be held is by no means limited to the shape shown or its cuboid basic shape. It can be designed in a variety of ways. The battery cell components 1 in the receiving regions 7 are held frictionally by the adjacent partition walls 13, after they have been moved together by the displacement screws 29 of the displacement mechanism 15 to the extent that a secure frictional connection is established between the battery cell components 1 and the partition walls 13.

In various embodiments, the springs 25 of the unpopulated workpiece carrier without battery cell components 1 are pretensioned in such a way that the depth of the receiving regions 7 as the distance between adjacent partition walls 13 is sufficient to easily insert the battery cell components 1 into the receiving regions 1 without the need for pressing. Through the displacement mechanism 15, the depth is reduced, the partition walls 13 move together, and a frictional connection is created by the partition walls 13 pushed together with the displacement screws 29.

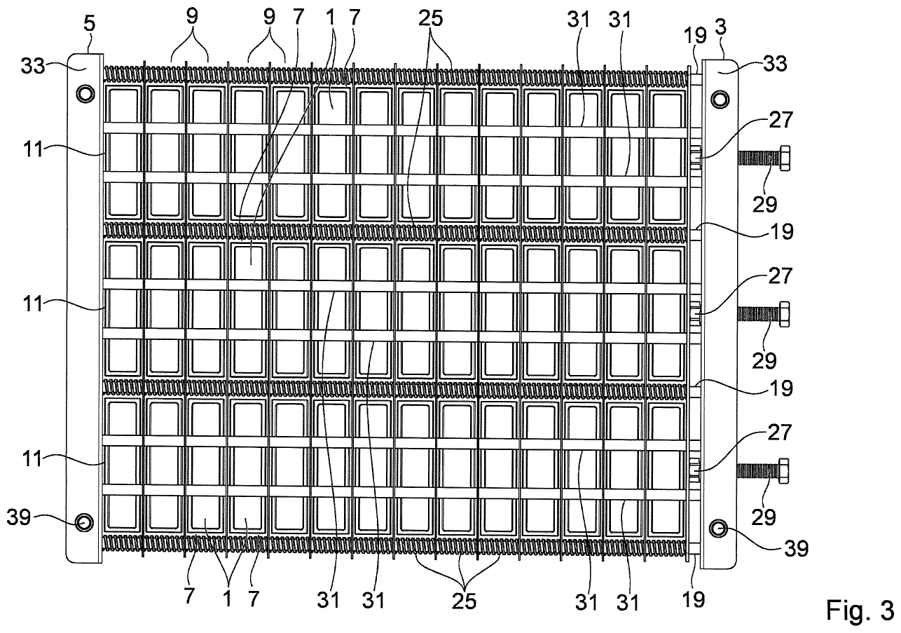

FIG. 3 shows a bottom view of the workpiece carrier. Holding rods 31 extend between adjacent longitudinal supports 19, on which the battery cell components 1 can be placed during assembly. In this exemplary embodiment, two holding rods 31 are arranged between two adjacent longitudinal supports 19. The holding rods 31 can, for example, have a round or square cross-section. The latter increases the contact surface. The holding rods 31 can be attached to the front and rear outer wall 3, 5 in the same way as the longitudinal support 19.

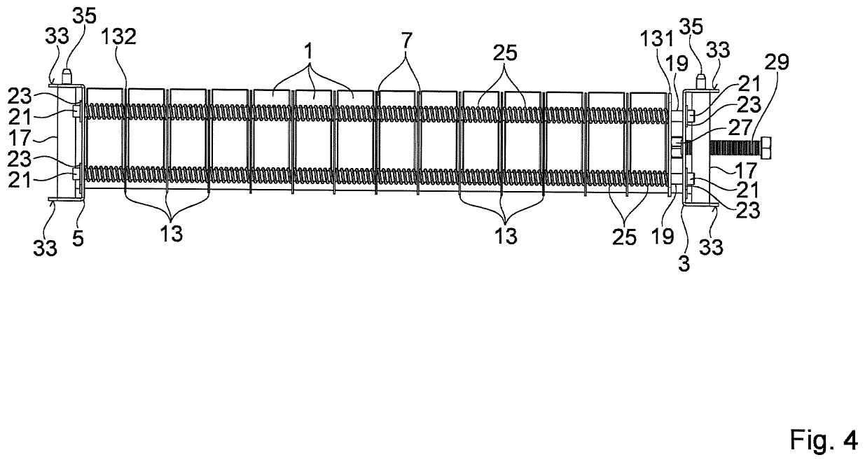

FIG. 4 shows a side view of the workpiece carrier.

The front outer wall 3 and the rear outer wall 5 are bent forward and backward at the top and bottom, respectively, so that support surfaces 33 are formed for stacking multiple workpiece carriers. Cylindrical stacking aids 17 extend between the support surfaces 33. Their tips 35 protrude through a hole in the upper support surface 33. At the lower front side of the stacking aid 17, there is a recess 39, whose position corresponds with a hole in the lower support 33. The tip 35 of another workpiece carrier can engage in the recess 39 to define the alignment of the workpiece carriers when stacking and to stabilize the stack against lateral slipping.

The partition walls 13 have holes for the longitudinal support 19 and the holding rods 31. The holes are designed in such a way that the partition walls 13 are movable along the longitudinal supports 19 and holding rods 31. The cross-sectional contours of the holes and the longitudinal support 19 and holding rods 31 correspond in one embodiment in their shape and size such that there is sufficient clearance for the shifting of the partition walls 13. In an alternative embodiment, the holding rods 31 are arranged below the partition walls 13.

Clearly visible is the distance defined by the screw nuts 27 of the first partition wall 131 in the basic position when the workpiece carrier is not loaded. The displacement of the partition walls 13 when fixing the battery cell components 1 is achieved by turning the displacement screws 29, so that their shaft ends move the first partition wall 131 away from the front outer wall 3. This movement is transmitted via the springs 25, and, if equipped, the battery cell components 1, to the other partition walls 13, so that by the movement of the displacement screws 29, the other partition walls 13 and battery cell components 1 are also pushed together until the battery cell components 1 are held by frictional connection. In this state, the workpiece carrier can then be moved and rotated without the battery cell components 1 falling out.

By turning the displacement screws 29 in the opposite direction, the battery cell components 1 are released, as this causes a movement of the partition walls 13 away from each other due to the spring force, thereby dissolving the frictional connection.

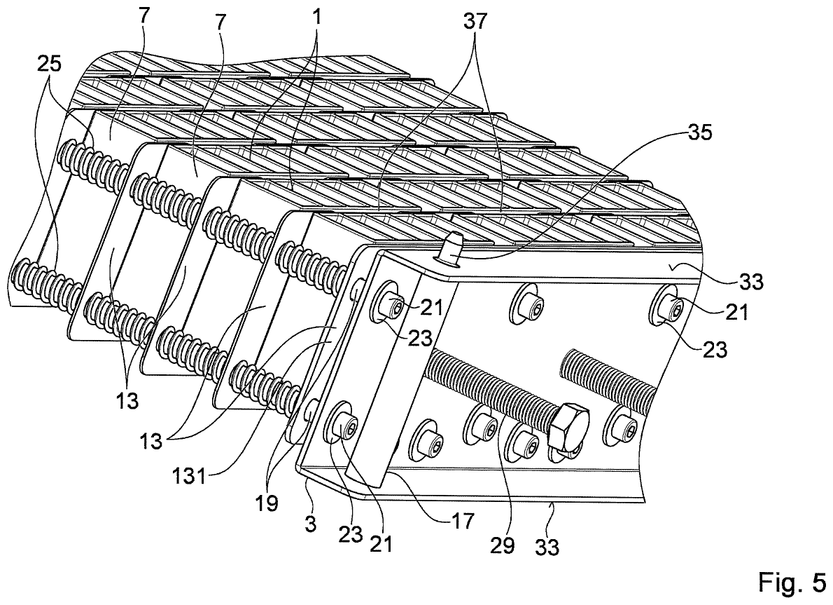

FIG. 5 shows a three-dimensional sectional view of the workpiece carrier in the front corner area. The distance of the first partition wall 131 from the front outer wall 3 is clearly visible, which can be adjusted by the displacement screws 29 of the displacement mechanism 15.

In this exemplary embodiment, the partition walls 13 have lowered portions 37 on their upper edge, which are in the center of the receiving regions 7. These lowered portions 37 facilitate the loading of the workpiece carrier, as a hand or machine inserting the battery cell components 1 can push the battery cell components 1 further into the receiving regions 7 than would be the case with a straight upper edge.

The features specified above and in the claims as well as the features shown in the figures can be realized both individually and in various combinations. The invention is not limited to the described embodiments, but can be modified in many ways within the scope of professional expertise.

The phrase at least one of A, B, and C should be construed to mean a logical (A OR B OR C), using a non-exclusive logical OR, and should not be construed to mean “at least one of A, at least one of B, and at least one of C.”

### Reference Signs

1 Workpiece/battery cell components
3 Front outer wall
5 Rear outer wall
7 Receiving region
9 Row
11 Column
13, 131, 132 Partition wall
15 Displacement mechanism
17 Stacking aid
19 Longitudinal support
21 Screw
23 Washer
25 Spring
27 Screw nut
29 Displacement screw
31 Holding rod
33 Support surface
35 Tip
37 Lowered portion
39 Recess

1-16. (canceled)

17. A workpiece carrier in which a plurality of workpieces can be arranged in an array, the workpiece carrier comprising:
at least two side longitudinal supports;
spring-loaded partition walls that extend between the at least two longitudinal supports, the spring-loaded partition walls being displaceable along the at least two longitudinal supports, wherein between two adjacent partition walls at least one receiving region for one or more workpieces of said plurality of workpieces is defined, the at least one receiving region being laterally delimited by adjacent longitudinal supports; and
a displacement mechanism, wherein the partition walls are displaceable against a spring force so that the workpieces are pressed into the at least one receiving region between adjacent partitions walls.

18. The workpiece carrier of claim 17, wherein the one or more workpieces from said plurality of workpieces are arranged in a row along the partition walls in the receiving regions.

19. The workpiece carrier of claim 17, wherein the longitudinal supports extend between two opposing outer walls.

20. The workpiece carrier of claim 17, wherein the receiving regions are arranged in rows and columns, and wherein the columns extend along the longitudinal supports and the rows extend along the partition walls.

21. The workpiece carrier of claim 17, further comprising:
outer longitudinal supports extending on opposite outer sides of said workpiece carrier.

22. The workpiece carrier of claim 21, wherein more than one outer longitudinal support extends on the same outer side of said workpiece carrier.

23. The workpiece carrier of claim 20, wherein more than one longitudinal support extends between two adjacent columns.

24. The workpiece carrier of claim 17, wherein at least one spring is coupled between the two adjacent partition walls.

25. The workpiece carrier of claim 24, wherein the at least one spring extends around the longitudinal support and bears against the partition walls in a preloaded state.

26. The workpiece carrier of claim 24, wherein the at least one spring is a coil spring.

27. The workpiece carrier of claim 17, wherein the displacement mechanism is configured to fix a displacement of the partition walls.

28. The workpiece carrier of claims 19, wherein a first partition wall is arranged adjacent to one of the two opposing outer walls and the displacement mechanism is configured to change a distance between the first partition wall and the outer wall.

29. The workpiece carrier of claim 17, wherein the displacement mechanism comprises a spacer.

30. The workpiece carrier of claim 29, wherein the displacement mechanism comprises an internal thread and a screw with an external thread that defines the spacer.

31. The workpiece carrier of claim 28, wherein at least one receiving region is defined between a second partition wall adjacent to one of the opposing outer walls and the outer wall, and wherein at least one spring is coupled between the second partition wall and the outer wall.

32. The workpiece carrier of claim 17, further comprising:
holding rods on which the workpieces can be placed extending between two opposing outer walls.
